(19) United States
(12) Patent Application Publication
(10) Pub. No.: US 2008/0196892 A1
(43) Pub. Date: Aug. 21, 2008

(54) Enzyme enhanced oil recovery (EEOR) for waterflooding operations

(76) Inventors: Philip Y. Lau, Houston, TX (US); John L. Gray, Houston, TX (US)

Correspondence Address: GUERRY LEONARD GRUNE, 784 S VILLIER CT., VIRGINIA BEACH, VA, 23452, US

(21) Appl. No.: 11/708,238

(22) Filed: Feb. 20, 2007

(51) Int. Cl. E21B 43/16; C09K 8/60; E21B 36/00

(52) U.S. Cl. 166/268; 166/302; 166/310; 166/369; 507/201

(57) ABSTRACT

The present disclosure involves the release or recovery of subterranean hydrocarbon deposits and, more specifically, to a system and method for secondary and/or enhanced oil recovery (EOR), by utilizing waterflooding compositions that include enzymes as well as methods for injecting waterflooding compositions into subterranean formations for oil recovery operations.

### FIELD OF INVENTION

The present disclosure relates to the release or recovery of subterranean hydrocarbon deposits and, more specifically, to a system for enhanced oil recovery (EOR), by utilizing enzyme compositions and waterflooding methods for injecting ambient, cold or heated fluids containing enzymes, followed by or during waterflooding of subterranean formations.

### BACKGROUND OF INVENTION

It is a common practice to treat production wells and other subterranean formations with various methodologies in order to increase petroleum, gas, oil or other hydrocarbon production using enhanced (secondary or tertiary) oil recovery. Enhanced oil recovery processes include Water-Alternating-Gas (WAG), cyclic steam, steamflood, waterflooding, in-situ combustion, the addition of micellar-polymer flooding, and microbial solutions.

### Definitions

One common practice regarding enhanced oil recovery is to treat viscous crude in subterranean formations using cyclic steam to increase overall recovery of original oil in place (OOIP) in wells or hydrocarbon zones that otherwise have low recovery rates. A cyclic steam-injection process includes three stages. The first stage is injection, during which a slug of steam is introduced into the reservoir. The second stage, or soak period, requires that the well be shut in for several days to allow uniform heat distribution to thin the oil. Finally, during the third stage, the thinned oil is produced through the same well. The cycle is repeated as long as oil production is profitable.

Cyclic steam injection is used extensively in heavy-oil reservoirs, tar sands, and in some cases to improve injectivity prior to steamflood or in-situ combustion operations.

Cyclic steam injection is also called steam soak or the huff ‘n’ puff (slang) method.

Steamflooding is another method of thermal recovery in which steam generated at the surface is injected into the reservoir through specially distributed injection wells.

When steam enters the reservoir, it heats up the crude oil and reduces its viscosity. The heat also distills light components of the crude oil, which condense in the oil bank ahead of the steam front, further reducing the oil viscosity. The hot water that condenses from the steam and the steam itself generate an artificial drive that sweeps oil toward producing wells.

Another contributing factor that enhances oil production during steam injection is related to near-wellbore cleanup. In this case, steam reduces the interfacial tension that ties paraffins and asphaltenes to the rock surfaces while steam distillation of crude oil light ends creates a small solvent bank that can miscibly remove trapped oil.

Steamflooding is also known as continuous steam injection or steam drive.

In-situ combustion is a method of thermal recovery in which fire is generated inside the reservoir by injecting a gas containing oxygen, such as air. A special heater in the well ignites the oil in the reservoir and starts a fire.

The heat generated by burning the heavy hydrocarbons in place produces hydrocarbon cracking, vaporization of light hydrocarbons and reservoir water in addition to the deposition of heavier hydrocarbons known as coke. As the fire moves, the burning front pushes ahead a mixture of hot combustion gases, steam and hot water, which in turn reduces oil viscosity and displaces oil toward production wells.

Additionally, the light hydrocarbons and the steam move ahead of the burning front, condensing into liquids, which adds the advantages of miscible displacement and hot waterflooding.

In-situ combustion is also known as fire flooding or fireflood.

Other types of in-situ combustion are dry combustion, dry forward combustion, reverse combustion and wet combustion which is a combination of forward combustion and waterflooding.

Micelles are a group of round hydrocarbon chains formed when the surfactant concentration in an aqueous solution reaches a critical point. The micellar costs depend upon the cost of oil, since many of these chemicals are petroleum sulfonates.

Micellar-polymer flooding is an enhanced oil recovery technique in which a micelle solution is pumped into a reservoir through specially distributed injection wells. The chemical solution reduces the interfacial and capillary forces between oil and water and triggers an increase in oil production.

The procedure of a micellar-polymer flooding includes a preflush (low-salinity water), a chemical solution (micellar or alkaline), a mobility buffer and, finally, a driving fluid (water), which displaces the chemicals and the resulting oil bank to production wells. The previously defined methods for enhanced oil recovery (EOR) all still leave residual hydrocarbons in the well. In some EOR, processes are combined to compensate for inefficiencies in one of more of the methods. In California, the injected steam volume is of the order of 10,000 barrels per cycle injected over about 2 weeks. In Cold Lake, Alberta, with oil viscosities that are 10-20 times higher than California, steam injection volumes are larger—perhaps 30,000 barrels per cycle injected over a month.

Hydraulic fracturing is accomplished by injecting a hydraulic fracturing fluid into the well and imposing sufficient pressure on the fracture fluid to cause formation breakdown with the attendant production of one or more fractures. Usually a gel, an emulsion or foam, having a proppant, such as sand or other suspended particulate material, is introduced into the fracture. The proppant is deposited in the fracture and functions to hold the fracture open after the pressure is released and fracturing fluid is withdrawn back into the well. The fracturing fluid has a sufficiently high viscosity to penetrate into the formation and to retain the proppant in suspension or at least to reduce the tendency of the proppant of settling out of the fracturing fluid. Generally, a gelation agent and/or an emulsifier is used in the fracturing fluid to provide the high viscosity needed to achieve maximum benefits from the fracturing process.

After the high viscosity fracturing fluid has been pumped into the formation and the fracturing has been completed, it is, of course, desirable to remove the fluid from the formation to allow hydrocarbon production through the new fractures. The removal of the highly viscous fracturing fluid is achieved by “breaking” the gel or emulsion or by converting the fracturing fluid into a low viscosity fluid. The act of breaking a gelled or emulsified fracturing fluid has commonly been obtained by adding a “breaker”, that is, a viscosity-reducing agent, to the subterranean formation at the desired time. This technique can be unreliable sometimes resulting in incomplete breaking of the fluid and/or premature breaking of the fluid before the process is complete reducing the potential amount of hydrocarbon recovery. Further, it is known in the art that most fracturing fluids will “break” if given enough time and sufficient temperature and pressure.

Several proposed methods for the breaking of fracturing fluids are aimed at eliminating the above problems such as introducing an encapsulated percarbonate, perchlorate, or persulfate breaker into a subterranean formation being treated with the fracturing fluid. Various chemical agents such as oxidants, i.e., perchlorates, percarbonates and persulfates not only degrade the polymers of interest but also oxidize tubulars, equipment, etc. that they come into contact with, including the formation itself In addition, oxidants also interact with resin coated proppants and, at higher temperatures, they interact with gel stabilizers used to stabilize the fracturing fluids which tend to be antioxidants. Also, the use of oxidants as breakers is disadvantageous from the point of view that the oxidants are not selective in degrading a particular polymer. In addition, chemical breakers are consumed stoichiometrically resulting in inconsistent gel breaking and some residual viscosity which causes formation damage.

Water-alternating-gas is an enhanced oil recovery process whereby water injection and gas injection are alternately injected for periods of time to provide better sweep efficiency and reduce gas channeling from the injector to the producer. This process is used primarily in miscible or immiscible CO₂ floods to improve hydrocarbon contact time and the sweep efficiency of the CO₂. This process is used to maintain or improve existing production while increasing the amount of original oil in place (OOIP) that is recovered beyond primary and secondary recovery methods. Other oxidized gases have also been shown to help increase oil yields.

The use of enzymes to break fracturing fluids may eliminate some of the problems relating to the use of gaseous oxidants. For example, enzyme breakers have been found to be very selective in degrading specific oxygen containing polymers such as partially hydrolyzed polyacrylamides, carboxylmethyl cellulose, or polyethylene oxide. The enzymes do not effect the tubulars, equipment, etc. that they come in contact with and/or damage the formation itself. The enzymes also do not interact with the resin coated proppants commonly used in fracturing systems. Enzymes react catalytically such that one molecule of enzyme may hydrolyze up to one hundred thousand (100,000) polymer chain bonds resulting in a cleaner more consistent break and very low residual viscosity. Consequently, formation damage is greatly decreased. Also, unlike oxidants, enzymes do not interact with gel stabilizers used to stabilize the fracturing fluids.

Waterflooding is a method of secondary recovery in which water is injected into the reservoir formation to displace residual oil. Waterflooding, in addition to using cold or ambient temperature water, may include hot water floods, warm water floods, or post-steamflood cold water injection that becomes hot water in reaction to the reservoir temperatures. The water from injection wells provides a water drive that physically sweeps the displaced oil to adjacent production wells. Potential problems associated with waterflood techniques include inefficient recovery due to variable permeability, or similar conditions affecting fluid transport within the reservoir, and early water breakthrough that may cause by-passing of original oil in place (OOIP) as well as production and surface processing problems. Waterflooding is generally used in recovery or higher American Petroleum Institute (API) gravity oils.

It has been discussed previously that there are several methods of recovering oil from individual wells or groups of wells, however, no art is disclosed that indicates an enzyme has been used as an additive for waterflooding operations in secondary oil recovery.

Therefore, there exists a need for a method of injecting an enzyme composition used in conjunction with waterflooding that improves the water's ability to recover additional oil, that has a wide temperature range for activity and being active at temperatures for preheating up to and about 80 to 90 degrees Celsius with additional subterranean liquid phase temperature stability under pressure, and is non-reactive with miscible or immiscible gases being injected. The disclosure provides several methods for injecting an enzyme composition as an additive in waterflooding treatments of hydrocarbon deposits, that is not a breaker for the dissolution of polymeric viscosifiers, but improves injectivity and oil recovery through its catalytic ability to release oil from solid surfaces while, at the same time, reducing surface tension and decreasing contact angle associated with the crude oil flow.

### DESCRIPTION OF PRIOR ART

U.S. Pat. No. 6,305,472, to Richardson, et. al., and assigned to Texaco Inc., describes a process for increasing recovery of oil from an oil reservoir by heating an injectant to a temperature of between about 220° F. to about 500° F., wherein the injectant is water, and an additive present at a concentration of between about 0.01% and about 20% by weight of the composition, wherein the additive is an organic compound having a total of 1 to 10 carbons and at least one functional group containing oxygen or sulfur; and injecting the heated injectant as a liquid into the oil reservoir such that the injectant does not result in emulsion formation upon injection into the oil reservoir.

U.S. Pat. No. 4,640,356, to Heinemann, et. al., and assigned to Chemie Linz Aktiengesellschaft, describes a process for the enhanced oil recovery of underground mineral oil deposits by selective, reversible reduction of the permeability using hot water flooding at an injection temperature of 150° to 250° C. and/or steam flooding at an injection temperature of 200° to 350° C., wherein hot water and/or steam is injected, at least at times, into the deposit via one or more injection boreholes, as a flooding medium which contains an active amount of one or more substances scarcely oil-soluble at the temperature of the deposit and a water solubility of below 3 kg/m3 water at 20° C. but well soluble or volatile in hot water and/or steam, the melting point of which lies above the temperature of the deposit and which moves with the hot water or the steam through the deposit and which, by precipitation as a solid in an amount of up to 4.3% of the pore volume, temporarily and reversibly constricts the pores of the deposit until flooding medium flowing on after dissolves or evaporates the solid again, which has the overall effect of an areal and vertical equalization of the temperature front.

U.S. Pat. No. 6,591,908, to Nasr, Tawfik N., and assigned to Alberta Science and Research Authority, describes a predominantly water-based thermal method for producing hydrocarbons from a subterranean formation having indigenous hydrocarbons, at least one producing means that can communicate with at least a portion of the formation, at least one injection means comprising a wellbore, and a mixing zone in a near-wellbore region of the wellbore, the method comprising: (a) selecting a first component, W, and a second component, S, wherein component W is selected from steam, hot water and combinations thereof, and component S is a solvent selected from C1 to C30 hydrocarbons, carbon dioxide, carbon monoxide and combinations thereof; (b) introducing at least component W and component S into the at least one injection means; (c) preparing a heated water-based injection fluid composition before, in or after the at least one injection means, the heated water-based injection fluid composition comprising at least component W and component S in a W to S volume ratio, defined by where the total number of injection sequencing intervals is in a range from about 2 to about 12,000, wherein the heated water-based injection fluid composition has a first W to S volume ratio, (W:S)1, greater than about 5:1 and the volume of component S injected in the first injection sequencing interval, where n=1, is greater than 0; (d) changing the ratio, at least once, from (W:S)1 to a different W to S volume ratio, (W:S)n, wherein at least one (W:S)n than (W:S)1 and each (W:S)n is greater than or equal to about 1.5:1; and (e) collecting at least a portion of the indigenous hydrocarbons using the at least one producing means.

U.S. Pat. No. 4,892,146, to Shen, Chin W., and assigned to Texaco Inc., describes a method of recovering petroleum from a subterranean, petroleum-containing, permeable formation penetrated by an injection well and a producing well comprising introducing into the formation via the injection well a predetermined quantity of steam having quality of from 0.0 to 99.0 weight percent, the stream entering and sweeping petroleum from a portion of the formation and displacing petroleum toward the producing well; recovering petroleum together with the injected fluids from the formation via the producing well; and thereafter injecting a liquid phase displacing fluid into the same portion of the formation as was swept by steam, said liquid containing a viscosifying amount of a hydrophillic polymer, from 0.005 to 2.0 percent by weight of an alkalinity agent and from 0.01 to 5.0 percent by weight of an alkalinity-stabilizing agent selected from the group consisting of sodium carbonate, sodium bicarbonate and mixtures thereof, with the liquid phase displacing fluid displacing petroleum through the formation to the production well and recovering petroleum via the producing well.

U.S. Pat. No. 4,508,170, to Littmann, Wolfgang, and unassigned, describes a process for increasing the yield of hydrocarbons from a subterranean formation consisting essentially of: passing either hot water without additives or steam into the formation, thereby heating the formation to a temperature of 100° to 250° C. and subsequently flooding the formation with a cold aqueous solution containing a polymer additive which increases its viscosity.

U.S. Pat. No. 4,884,635, to McKay, et. al., and assigned to Texaco Inc., describes a method of recovering hydrocarbons from an underground hydrocarbon formation penetrated by at least one injection well and at least one production well, which comprises: injecting into the formation a mixture of hot water and about 0.1% to about 10% by weight of a hydrocarbon liquid having an aromatic content greater than about 30%, with the hot water and hydrocarbon mixture injected at a temperature higher than about 80° C.; and recovering hydrocarbons and other fluids at a production well.

U.S. Pat. No. 3,796,262, to Allan, et. al., and assigned to Texaco Inc., describes a method of recovering oil from an oil bearing reservoir containing a finite water saturation which lacks sufficient energy to produce applicable oil by natural means, wherein there is at least one input well and one output well penetrating and in communication with the reservoir, and wherein the method includes the steps of injecting steam into the reservoir through the input wells at a rate exceeding the volumetric production from the output wells thereby increasing the temperature and pressure in substantially all of the reservoir to a point whereby the flash point of water in the reservoir is above the original pressure before injection began, stopping injection of steam and producing the output wells at maximum rate so that the pressure in the reservoir drops to the flash point of the water present in the reservoir or below and continuing to produce the output wells at any desired rate.

U.S. Pat. No. 5,055,493, to Leder, Jonathan, and assigned to Union Carbide, describes a method of killing or inhibiting the growth of bacteria in a liquid employed in an oil well flooding operation which comprises contacting the liquid with a bactericidally effective amount of a composition comprised of at least one biocide selected from the group consisting of: (a) 2,2-dibromo-2-nitroethanol, (b) 2,2-dibromo-2-nitroethanol and at least one other halonitroalkanol biocide, and (c) 2,2-dibromo-2-nitroethanol and at least one other biocide which is a non-halonitroalkanol biocide,with the proviso that when biocide is present, 2,2-dibromo-2-nitroethanol comprises at least 10 weight percent of the total active biocide and the flooding the oil well with the liquid.

U.S. Pat. No. 4,475,590, to Brown, Lewis R., and assigned to Standard Oil Co., describes a method of oil recovery from an oil-bearing subterranean formation involving stimulating the growth of an in-situ microbial population, wherein the microbial population's growth is partially limited because of deficiencies in the amounts of nitrogenous- and phosphorus- containing compounds available in the formation, with the formation being penetrated by at least one injection well and at least one producing well, comprising injecting into the formation an aqueous nitrogenous solution; injecting into the formation an aqueous phosphorus-containing solution; adjusting the amount of injected aqueous nitrogenous solution and aqueous phosphorus-containing solution to control the growth of the microbial population and injecting a drive fluid into the formation to displace oil to the production well.

U.S. Pat. No. 3,946,812, to Gale, et. al., and assigned to Exxon, describes a method of recovering crude oil from a subterranean formation by a waterflooding process, the improvement wherein the waterflood is preceded by injection into the formation of a slug of a transparent, aqueous solution of a water-soluble, sulfated, polyethoxylated alcohol, with the aqueous solution being substantially free of any other thickening agent and any other surface active agent.

U.S. Pat. No. 7,001,872, to Pyecroft, et. al., and assigned to Halliburton Energy Services, describes a method of fracturing a subterranean formation comprising the steps of: introducing a first treating fluid into the formation at or near a zone of interest within the formation, to create or enhance at least one fracture therein, the first treating fluid being a gelled and crosslinked treating fluid comprising water, a substantially fully hydrated depolymerized polymer and a crosslinking agent for crosslinking the substantially hydrated depolymerized polymer; introducing a second treating fluid into the formation such that a length of at least one fracture therein is extended, the second treating fluid having a lower viscosity than the first treating fluid; and introducing a third treating fluid into the formation, the third treating fluid being a gelled and crosslinked treating fluid comprising water, a substantially fully hydrated depolymerized polymer and a crosslinking agent for crosslinking the substantially hydrated depolymerized polymer and further comprising a proppant material.

U.S. Pat. No. 3,804,714, to Azoulay, et. al., and assigned to The British Petroleum Company Ltd., describes a process for the enzymic oxidation of a substantially water insoluble carbon containing substrate selected from the group consisting of a hydrocarbon, alcohol, and aldehyde which process comprises forming a solution of the substrate in an amide which is miscible with both water and the substrate and having the formula where R1, R2 and R3 are each selected from the group consisting of hydrogen and a C1 to C5 aliphatic group, dispersing the solution of substrate in the amide in an aqueous buffer solution having a pH in the range 6.5 to 9.5 and in the presence of a substrate oxidising enzyme extracted from a microorganism and a co-enzyme, to give a reaction mixture containing from a trace to 50 percent by volume of the solution of the substrate in the amide and maintaining the reaction mixture in the presence of oxygen at a temperature in the range

Chinese Patent Publication No CN1172845A, to Guoguang, Yang, and unassigned, describes a bio-enzyme modified fuel emulsion containing such components as diesel oil (35-45), heavy oil (35-45), water (15-25) and bio-enzyme (0.1-0.5) in percent by weight.

Chinese Patent Publication No CN1766283A, to Haifang Ge, and assigned to Dongying Shengshi Petroleum Technology Co. Ltd., describes an oil field oil-water well fracturing craft method of biological enzyme agent, which is characterized by the following: building the mixed biological enzyme agent and water or biological acid or antisludging agent or liquid nitrogen as fracturing fluid; forcing the fracturing fluid into the oil well or water well through the fracturing vehicle; pressing the fracturing fluid into the crack; opening the well after 72 hours. The biological enzyme agent penetrates the hole throat then enters into the microscopic hole gap, which attaches the rock surface and denudes the raw oil to improve the earth penetration factor. The method improves the water wet effect and washes the spalling oil film, which improves the recovery factor of raw oil.

Chinese Patent Publication No CN1710014A, to Li, Chen Zhao, and assigned to Wotaisi Chemical Co. Ltd., describes an invention relating to a kind of biological enzyme oil driving agent used for improving crude oil extraction rate and oil driving method. It mainly solves the problems in present oil driving process that: the stability is bad, it is greatly effected by temperature, it can't degrade, is nocuous, has corrosiveness, can cause oil layer form smudgily, and bring pollution to stratum and environment. Its characteristics are: the biology enzyme oil driving agent is comprised of following weight percents of components: biology enzyme 12-20%, diquaternary salt 0.4-12%, alkyl polysaccharide glucoside (C8-10APG) 0.4-12%, and the remaining is water. The biological enzyme oil driving method can effectively improve affusion ability, decrease petroleum granulated substance carrying ability, reduce the friction liquid and sandstone, so as to achieve the purpose of stabilizing oil storage and improving the recovery ratio.

### SUMMARY OF THE DISCLOSURE

One embodiment of the disclosure includes a method and system of removing petroleum, oil and other hydrocarbon deposits releasable by a substance from a subterranean formation below a surficial formation. The method and system, according to this disclosure, comprises, in combination, the steps of providing a hole through the surficial formation to the subterranean formation, optionally injecting an enzyme fluid through the surficial formation to the subterranean formation in a form of pretreatment or later staged addition, storing the substance in the form of a liquid at the subterranean formation. Also, for injection, providing a fluid that has temperature stability sufficient for a sustained liquid phase of the enzymatic fluid under pressure at the subterranean formation. The ability to drive the liquid into the subterranean formation in a waterflooding stage for releasing hydrocarbon deposits with that liquid moving from at least one injection well to one or more producing wells, and removing such released deposits from the subterranean formation using enzymatic fluids is part of the disclosure.

The waterflood composition is injected into the subterranean formation through at least one injection well for releasing hydrocarbon deposits and removing released deposits from the subterranean formation thru one or more producing wells separate from the injection well in combination with the enzymatic fluid.

Another embodiment of the disclosure is a method and system for injecting an enzyme composition into a well as a treatment for secondary and/or enhanced oil recovery (EOR) within a waterflooding process cycle.

Another embodiment of the disclosure is a method and system for injecting an enzyme composition into a well where the waterflooding process cycle includes hot water floods, warm water floods, or post-steamflood cold water injection that becomes hot water in reaction to the reservoir temperatures.

Another embodiment of the disclosure includes the use of GREENZYME® as the enzyme composition before waterflooding as a pretreatment or during waterflooding as an active treatment of at least one injection well and one or more producing oil wells which increases the rate at which oil is released and produced as well as increased percent recovery of original oil in place (OOIP).

Another embodiment includes the use of an enzyme composition for treatment between waterflood cycles or treatment of the well during the waterflood cycle such that the enzyme can be injected as a heated liquid into the well if needed. The use of an enzyme heated to 80 to 90 degrees Celsius before injection into a well to minimize pour point flow restrictions and to maximize injection pressure efficiency of the injected water or gas is another aspect of the disclosure. It is noted that the enzyme is active in a diluted range of 0.01 to 100 percent and is suitable, but not limited to, a working range of 3 to 10 percent for injection with water. Injection of the enzyme may have different points of addition and can occur along with large injections of water or in concentrated or diluted enzyme fluids that are injected “on the fly” to water lines that actively pump water.

Another embodiment may include metered additions of the enzyme added to water slugs or pulsed into water being added to maximize efficient use of the enzyme and optimize waterflood performance.

Another embodiment includes the use of an enzyme composition to be injected into a subsurface formation to improve the mobility of heavier crude oil or lower API gravity oil going from the injection well to one or more producing wells and to prevent plugging in producing wellbores or restricted flow areas as well as unplugging the pipelines.

Another embodiment is the use of an enzyme composition for penetrating asphaltenes and waxes at the injection wellbore prior to or during waterflooding as well as minimizing similar build up that can occur at one or more producing wellbores during production.

Another embodiment includes use of an enzyme in waterflooding operations such that the enzyme does not affect the normal function in the surrounding well formations as it moves from an injection well to one or more producing wells.

### BRIEF DESCRIPTION OF THE DRAWINGS

FIG. 1 is a schematic of waterflooding operations with an optional pretreatment stage using an enzyme composition such as GREENZYME®.

### DETAILED DESCRIPTION

Disclosed is an improvement of common secondary to waterflooding processes to tertiary oil recovery processes that utilize an enzyme based water composition to increase the ability of the waterflooding phase to recover, mobilize and produce oil. In particular an enzyme trademarked as GREENZYME®, by Apollo Separation Technologies, Inc. of Houston, Tex. GREENZYME® is a biological enzyme that is a protein based, non-living catalyst for penetrating and releasing oil from solid surfaces and demonstrates the following attributes: GREENZYME® has the effect of increasing the mobility of the oil by reducing surface tension, decreasing contact angles and preventing crude oil that has become less viscous by heating or other means, from re-adhering to itself as it cools.

GREENZYME® is active in water and acts catalytically in contacting and releasing oil from solid surfaces.

GREENZYME® is effective up to 270 degrees Celsius in liquid phase under pressure and is not restricted by variations in the American Petroleum Institute (API) specific gravity ratings of the crude oil.

GREENZYME® is not an oil viscosity modifier nor does it change the chemical composition of the oil.

GREENZYME® is not reactive with miscible or immiscible gases.

GREENZYME® is not a live microbe and does not require nutrients or ingest oil.

GREENZYME® does not grow or plug an oil formation or release cross-linked polymers.

GREENZYME® does not trigger any other downhole mechanisms, except to release oil from the solid substrates. (ie: one function).

GREENZYME® is not pH sensitive and can be used with various types of water compositions used in waterflooding operations.

Other suitable enzymes other than GREENZYME® are also the subject of the present disclosure and can be used interchangeably, together with or separately from GREENZYME® to meet the EOR requirements of individual wells.

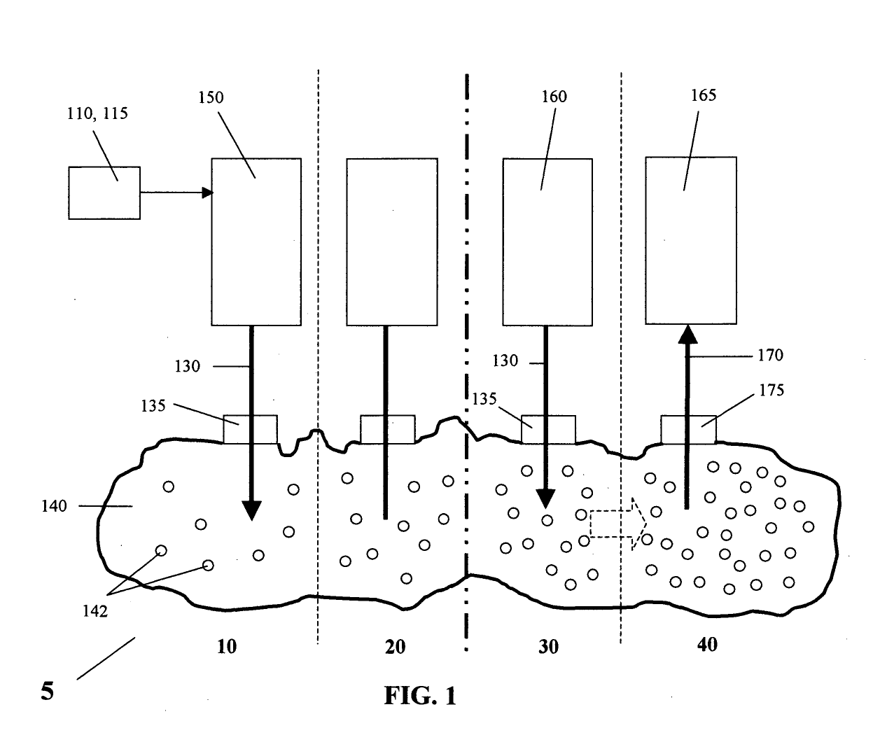

Referring to FIG. 1, in an overview, the water and enzyme system comprising a waterflooding enzyme composition [5] is comprised of four (4) stages. The first stage includes an optional enzyme water composition pretreatment stage [10] with at least one injection well, an alternative period of idle process known as the pretreatment soak stage [20], followed by the waterflooding stage [30] and then a recovery stage [40] of produced oil by one or more producing wells that are designed and configured to recovery oil from one or more injection wells. This waterflooding enzyme composition system [5] can be sequential or intermittent and may be repeated as a (4) step sequence or in a two stage sequence using just the waterflooding stage [30] and recovery stage [40] and is based on the economics and availability of water, energy requirements to both produce oil and recover water as well as the ability to re-inject or dispose of the water, the ability of surface equipment handle large volumes of water, and increased production and recovery rates achieved thru the combination of waterflooding with enzyme addition. The water composition of the waterflooding stage [30] may include any substance known to those skilled in the art.

During the pretreatment stage [10], enzymes [115], such as GREENZYME® [110], are added to water and flow to an injection pump [150] where it is then pumped down an injection pipe [130], through the downhole well bore [135] and into the oil well formation [140]. The waterflood enzyme composition [5] acts to release the oil from solid surfaces, increase the mobility of the oil by reducing surface tension, decreasing contact angles, preventing crude oil that has become less viscous by heating or other means, from re-adhering to itself as it cools and acts catalytically in contacting and releasing oil from solid surfaces. Blockages in the oil well formation [140] may be reduced or eliminated as well. The enzymes [115] are pushed into the oil well formation [140] to further contact oil particles [142] thereby increasing contact volume.

The pretreatment soak stage [20] as it is known, allows the waterflooding enzyme composition [5] to permeate the oil well formation [140] and the enzymes [115] to reach maximum oil releasing efficiency. The enzymes [115] remains active in the water or hot water compositions and acts catalytically in contacting and releasing oil from solid surfaces. It is not restricted by variations in the American Petroleum Institute (API) specific gravity ratings of the crude oil. The pretreatment soak stage [20] may last between 0-30 days depending on the type and size of the oil well formation [140]. The pretreatment soak stage [20] may be omitted when there is no enzyme pretreatment stage [10].

Following the pretreatment soak stage [20] is a waterflooding stage [30] to which a water injection pump [160] is connected to the oil well formation [140] via an injection pipe [130] and a wellbore [135]. The waterflood enzyme composition [5], under pressure, floods into the oil well formation [140] via an injection pipe [130] and a wellbore [135]. The waterflood enzyme composition [5] displaces the oil particles [142] toward the part of the oil well formation [140] where recovery operations occur.

Closely following the waterflooding stage [30] is the recovery stage [40] in which one or more producing well [165] is connected to the oil well formation [140] via a retrieval pipe [170] and an uphole well bore [175]. In the recovery stage [40], the producing well [165] is activated causing the oil particles [142] to be transferred from the oil well formation [140] through the uphole well bore [175] and retrieval pipe [170] to be transferred for refining.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim;

1. An enhanced recovery of oil or other hydrocarbon deposits in a subterranean formation wherein said hydrocarbon deposits are releasable by initial or later stage addition of an enzymatic fluid combined with water, thereby forming a waterflooding enzyme composition that is added to a pump for pumping said waterflooding enzyme composition into said subterranean formation through an injection well, followed by an additional period of time or time of transit allowing said waterflooding enzyme composition to soak said subterranean formation wherein said waterflooding enzyme composition is moving from said injection well to one or more producing wells within said subterranean formation, followed by recovery of said hydrocarbon deposits by pumping or other means from said subterranean formation.

2. The enzymatic fluid of claim 1, wherein said pumping of said fluid independently or together with said waterflooding enzyme composition for injection is provided during pre-soaking of one or more injection or producing wells, allowing for subsequent recovery of said hydrocarbon deposits such that said pumping of said fluid or composition or combination of said fluid and composition may be sequential or modified and repeated as required to optimize production and economics.

3. The waterflooding enzyme composition of claim 1, wherein said waterflooding enzyme composition may contain any substance or combination of substances useful for enhanced oil recovery.

4. The enzymatic fluid of claim 1, wherein said enzymatic fluid is GREENZYME® and wherein said hydrocarbon deposits include crude oil.

5. The enzymatic fluid of claim 1, wherein said enzymatic fluid is used for treatment of the subterranean formation during waterflooding wherein said enzymatic fluid is injected as either a cold, heated or ambient liquid into said formation and may be pulsed into water slugs that themselves are cold, heated or ambient temperature.

6. The enzymatic fluid of claim 1, wherein said enzymatic fluid can be heated to at least 80 degrees Celsius before injection into an injection well.

7. The enzymatic fluid of claim 1, wherein said enzymatic fluid is diluted with water in a range of 0.01 to 99 percent and more specifically is diluted within a working range of 3 to 10 percent of enzymatic fluid in water.

8. The enzymatic fluid of claim 1, wherein said enzymatic fluid is incrementally diluted to stimulate wells that are at an unacceptable level of production prior to restarting a waterflooding and enzyme injection process wherein said waterflooding and enzyme injection process increases the rate at which oil is released and produced and increases recovery of original oil in place (OOIP).

9. The enzymatic fluid of claim 1, wherein said enzymatic fluid is used for pre-treatment or treatment of said formation during enhanced oil recovery such that said enzymatic fluid is injected and intermixed with water which is sent into said formation and wherein said formation is a well that is subsequently not used for a period of time allowing for soaking of said well prior to another phase of enhanced oil recovery including, but not limited to pumping and use of waterflooding for one or more cycles during said recovery.

10. The enzymatic fluid of claim 1, wherein said enzymatic fluid or a diluted combination of fluid and water is injected into pipelines to prevent crude or lower API gravity oil from plugging said pipelines.

11. The enzymatic fluid of claim 1, wherein said enzymatic fluid reduces asphaltines and waxes at an injection wellbore prior to injection as well as minimizing wellbore build up during production that occurs at an end of an enhanced oil recovery cycle, wherein said cycle includes a waterflooding and enzyme system.

12. The enzymatic fluid of claim 1, wherein during waterflooding operations said enzymatic fluid does not affect the normal heat transfer provided by said waterflooding to surrounding well formations or to said hydrocarbon deposits, wherein said hydrocarbon deposits include crude oil.

13. A method for enhanced recovery of oil or other hydrocarbon deposits in a subterranean formation using an enzymatic fluid combined with water forming a waterflooding enzyme composition, wherein said hydrocarbon deposits are releasable by initially adding said waterflooding enzyme composition directly to a pump for pumping into said subterranean formation through an injection well followed by an additional period of time allowing said waterflooding enzyme composition to soak said subterranean formation wherein said waterflooding enzyme composition is moving from said injection well to one or more producing wells within said subterranean formation, followed by recovery of said hydrocarbon deposits by pumping or other means from said subterranean formation.

14. The method of enhanced oil recovery of claim 13, wherein said pumping of said fluid independently or together with said waterflooding enzyme composition for injection is provided during pre-soaking of one or more injection or producing wells, allowing for subsequent recovery of said hydrocarbon deposits such that said pumping of said fluid or composition or combination of said fluid and composition may be sequential and repeated as required.

15. The method of enhanced oil recovery of claim 13, wherein said waterflooding enzyme composition provided may contain any substance or combination of substances useful for enhanced oil recovery.

16. The method of enhanced oil recovery of claim 13, wherein said enzymatic fluid provided is GREENZYME® and wherein said hydrocarbon deposits include crude oil.

17. The method of enhanced oil recovery of claim 13, wherein injecting said enzymatic fluid conditions the subterranean formation during waterflooding wherein said enzymatic fluid is injected as either a cold, heated or ambient liquid into said formation and may be pulsed into water slugs that themselves are cold, heated or ambient temperature.

18. The method of enhanced oil recovery of claim 13, wherein said enzymatic fluid can be heated to at least 80 degrees Celsius before injection into an injection well.

19. The method of enhanced oil recovery of claim 13, wherein diluting said enzymatic fluid with water in a range of 0.01 to 99 percent and more specifically wherein said enzymatic fluid is diluted within a working range of 3 to 10 percent of enzymatic fluid in water.

20. The method of enhanced oil recovery of claim 13, wherein incrementally diluting said enzymatic fluid stimulates wells that are at an unacceptable level of production prior to restarting a waterflooding and enzyme injection process wherein said waterflooding and enzyme injection process increases the rate at which oil is released and produced.

21. The method of enhanced oil recovery of claim 13, wherein pre-treatment of said formation with said enzymatic fluid enhances oil recovery such that said enzymatic fluid is injected and intermixed with water which is sent into said formation and wherein said formation is a well that is subsequently not used for a period of time allowing for soaking of said well prior to another phase of enhanced oil recovery including, but not limited to pumping and use of waterflooding for one or more cycles during said recovery.

22. The method of enhanced oil recovery of claim 13, wherein diluting said enzymatic fluid or a combination of fluid and water and injecting into pipelines prevents crude or lower API gravity oil from plugging said pipelines.

23. The method of enhanced oil recovery of claim 13, wherein application of said enzymatic fluid at an injection wellbore reduces asphaltines and waxes prior to injection as well as minimizing wellbore build up during production that occurs at an end of an enhanced oil recovery cycle, wherein said cycle includes a waterflooding and enzyme system.

24. The method of enhanced oil recovery of claim 13, wherein during waterflooding operations said enzymatic fluid does not affect the normal heat transfer provided by said waterflooding to surrounding well formations or to said hydrocarbon deposits, wherein said hydrocarbon deposits include crude oil.

25. An system for enhanced recovery of oil or other hydrocarbon deposits in a subterranean formation wherein said hydrocarbon deposits are releasable by initial or later stage addition of an enzymatic fluid combined with water, thereby forming a waterflooding enzyme composition that is added to a pump for pumping said waterflooding enzyme composition into said subterranean formation through an injection well, followed by an additional period of time or transit time allowing said waterflooding enzyme composition to soak said subterranean formation wherein said waterflooding enzyme composition is moving from said injection well to one or more producing wells within said subterranean formation, followed by recovery of said hydrocarbon deposits by pumping or other means from said subterranean formation.

26. The system for enhanced recovery of oil of claim 25, wherein said pumping of said fluid independently or together with said waterflooding enzyme composition for injection is provided during pre-soaking of one or more injection or producing wells, allowing for subsequent recovery of said hydrocarbon deposits such that said pumping of said fluid or composition or combination of said fluid and composition may be sequential and repeated as required.

27. The system for enhanced recovery of oil of claim 25, wherein said waterflooding enzyme composition may contain any substance or combination of substances useful for enhanced oil recovery.

28. The system for enhanced recovery of oil of claim 25, wherein said enzymatic fluid is GREENZYME® and wherein said hydrocarbon deposits include crude oil.

29. The system for enhanced recovery of oil of claim 25, wherein said enzymatic fluid is used for treatment of the subterranean formation during waterflooding wherein said enzymatic fluid is injected as either a cold, heated or ambient liquid into said formation and may be pulsed into water slugs that themselves are cold, heated or ambient tempearture.

30. The system for enhanced recovery of oil of claim 25, wherein said enzymatic fluid can be heated to at least 80 degrees Celsius before injection into an injection well.

31. The system for enhanced recovery of oil of claim 25, wherein said enzymatic fluid is diluted with water in a range of 0.01 to 99 percent and more specifically is diluted within a working range of 3 to 10 percent of enzymatic fluid in water.

32. The system for enhanced recovery of oil of claim 25, wherein said enzymatic fluid is incrementally diluted to stimulate wells that are at an unacceptable level of production prior to restarting a waterflooding and enzyme injection process wherein said waterflooding and enzyme injection process increases the rate at which oil is released and produced.

33. The system for enhanced recovery of oil of claim 25, wherein said enzymatic fluid is used for pre-treatment or treatment of said formation during enhanced oil recovery such that said enzymatic fluid is injected and intermixed with water which is sent into said formation and wherein said formation is a well that is subsequently not used for a period of time allowing for soaking of said well prior to another phase of enhanced oil recovery including, but not limited to pumping and use of waterflooding for one or more cycles during said recovery.

34. The system for enhanced recovery of oil of claim 25, wherein said enzymatic fluid or a diluted combination of fluid and water is injected into pipelines to prevent crude or lower API gravity oil from plugging said pipelines.

35. The system for enhanced recovery of oil of claim 25, wherein said enzymatic fluid reduces asphaltines and waxes at an injection wellbore prior to injection as well as minimizing wellbore build up during production that occurs at an end of an enhanced oil recovery cycle, wherein said cycle includes a waterflooding and enzyme system.

36. The system for enhanced recovery of oil of claim 25, wherein during waterflooding operations said enzymatic fluid does not affect the normal heat transfer provided by said waterflooding to surrounding well formations or to said hydrocarbon deposits, wherein said hydrocarbon deposits include crude oil.
